(19) United States
(12) Patent Application Publication
(10) Pub. No.: US 2012/0033338 A1
(43) Pub. Date: Feb. 9, 2012

(54) MONITORING DEVICE FOR AN ELECTRICAL POWER SOURCE AND LOAD

(75) Inventors: Colin Van Leeuwen, Vancouver (CA); Paul Joseph Jungwirth, Burnaby (CA)

(73) Assignee: KONINKLIJKE PHILIPS ELECTRONICS N.V., EINDHOVEN (NL)

(21) Appl. No.: 13/264,119

(22) PCT Filed: Apr. 1, 2010
(86) PCT No.: PCT/IB10/51441

§ 371 Date: Oct. 12, 2011

Related U.S. Application Data
(60) Provisional application No. 61/170,699, filed on Apr. 20, 2009.

(51) Int. Cl. H02H 3/00

(52) U.S. Cl. 361/62

(57) ABSTRACT

Disclosed is a device for monitoring an electrical power flow between a power source and a load. The monitoring device includes a monitoring module configured to monitor one or more aspects of the electrical power flow, the monitoring module configured to detect a fault condition when one or more aspects fall outside a predetermined operating range. In addition, the device includes a protection module configured to interrupt the electrical power flow upon detection of the fault condition. In some embodiments, the monitoring device includes a reset module configured to re-establish electrical power flow between the power source and the load. In some embodiments, the monitoring device further includes a diagnostic module configured to determine diagnostic information based at least in part on one or more of the monitored aspects of the electrical power flow.

### TECHNICAL FIELD

The present invention is directed generally to monitoring devices. More particularly, various inventive methods and apparatus disclosed herein relate to a monitoring device for an electrical power source and load.

### BACKGROUND

Digital lighting technologies, i.e. illumination based on semiconductor light sources, such as light-emitting diodes (LEDs), offer a viable alternative to traditional fluorescent, HID, and incandescent lamps. Functional advantages and benefits of LEDs include high energy conversion and optical efficiency, durability, lower operating costs, and many others. Recent advances in LED technology have provided efficient and robust full-spectrum lighting sources that enable a variety of lighting effects in many applications. Some of the fixtures embodying these sources feature a lighting module, including one or more LEDs capable of producing different colors, e.g. red, green, and blue, as well as a processor for independently controlling the output of the LEDs in order to generate a variety of colors and color-changing lighting effects.

LEDs are typically energized via an LED driver which receives power from a power supply. With certain power supply or LED driver designs, the load, for example the LED, is not protected from an over-current condition due to a short circuit or damage to the load. In this case, the power supply or LED driver will continue to supply full current to the load, which may cause major damage to the load. Furthermore, should the power supply or driver be providing the load with a low input voltage, this may adversely affect the performance of the load.

Power monitoring modules for detecting various electrical parameters of a device plugged into a power source are known in the art. Some of these monitoring modules include a display unit capable of displaying relevant electrical parameters of the power source and the device plugged into the power source, wherein these parameters can include voltage value, current value, watt, kilowatt-hour etc.

Furthermore, in the art there is also a protection circuitry which is integrated into the electrical system of a docking station base. The protection circuitry removes power to the docking station should the power supply voltages and currents outside a specified range, and further includes a visual indication of the over current and under/over voltage conditions.

In addition, there is a power protecting device which is for monitoring an electrical power source and load and securing the safety of operation. The power protecting device is capable of protecting an electric appliance by cutting the power supply at abnormal conditions like over current, over voltage, under voltage and over power. The power protecting device further includes a power on delay circuit capable of delaying the power supply to an electric appliance for a predetermined period of time, wherein the predetermined time is dependent on the time of power termination. This power protecting device will however, after the predetermined period of time, resupply the power to the load, which may be detrimental to the load should there be a fault with the power supply or the load, thereby potentially resulting in further damage thereto.

Thus, there is a need in the art to provide methods and apparatus that can provide a desired level of monitoring, and protection to a load which is coupled to a power source, such that the load and/or power source may be protected from potential undesired power conditions.

### SUMMARY

The present disclosure is directed to inventive methods and apparatus for a monitoring device for an electrical power supply and load. For example, the monitoring device can be used in conjunction with a power supply or LED driver and one or more strings of one or more LEDs.

Generally, in one aspect of the invention there is provided a device for monitoring an electrical power flow between a power source and a load and for protecting the load. The device includes a monitoring module configured to monitor one or more aspects of the electrical power flow, wherein the monitoring module is configured to detect a fault condition when one or more aspects fall outside a predetermined operating range. In addition, the device includes a protection module configured to interrupt the electrical power flow upon detection of the fault condition.

In accordance with embodiments of the invention, the device for monitoring further comprises a reset module configured to re-establish the electrical power flow following a user initiated reset action. In some versions, the reset module is configured to re-establish the electrical power flow after a predetermined period of time following the reset action.

In accordance with embodiments of the invention, the monitoring module further comprises a fault counter configured to increment a fault count when the one or more aspects fall outside a predetermined operating range, wherein a fault condition is determined when the fault count exceeds a predetermined threshold.

In accordance with embodiments of the invention, the device for monitoring further comprises a diagnostic module configured to provide diagnostic information to a user following detection of the fault condition, said diagnostic information based at least on the one or more aspects monitored prior to the fault condition.

In accordance with an aspect of the invention there is provided a method for monitoring and controlling electrical power flow from a power source to a load, the method comprising the steps of: sampling one or more aspects of the electrical power flow; comparing the one or more aspects with a predetermined operating range associated therewith; determining a fault condition at least in part when the one or more aspects are outside of the predetermined operating range; and interrupting the electrical power flow upon determination of a fault condition.

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like. In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers). Some examples of LEDs include, but are not limited to, various types of infrared LEDs, ultraviolet LEDs, red LEDs, blue LEDs, green LEDs, yellow LEDs, amber LEDs, orange LEDs, and white LEDs (discussed further below). It also should be appreciated that LEDs may be configured and/or controlled to generate radiation having various bandwidths (e.g., full widths at half maximum, or FWHM) for a given spectrum (e.g., narrow bandwidth, broad bandwidth), and a variety of dominant wavelengths within a given general color categorization.

For example, one implementation of an LED configured to generate essentially white light (e.g., a white LED) may include a number of dies which respectively emit different spectra of electroluminescence that, in combination, mix to form essentially white light. In another implementation, a white light LED may be associated with a phosphor material that converts electroluminescence having a first spectrum to a different second spectrum. In one example of this implementation, electroluminescence having a relatively short wavelength and narrow bandwidth spectrum “pumps” the phosphor material, which in turn radiates longer wavelength radiation having a somewhat broader spectrum.

It should also be understood that the term LED does not limit the physical and/or electrical package type of an LED. For example, as discussed above, an LED may refer to a single light emitting device having multiple dies that are configured to respectively emit different spectra of radiation (e.g., that may or may not be individually controllable). Also, an LED may be associated with a phosphor that is considered as an integral part of the LED (e.g., some types of white LEDs). In general, the term LED may refer to packaged LEDs, non-packaged LEDs, surface mount LEDs, chip-on-board LEDs, T-package mount LEDs, radial package LEDs, power package LEDs, LEDs including some type of encasement and/or optical element (e.g., a diffusing lens), etc.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radioluminescent sources, and luminescent polymers.

The term “lighting fixture” is used herein to refer to an implementation or arrangement of one or more lighting units in a particular form factor, assembly, or package. The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources. A “multi-channel” lighting unit refers to an LED-based or non LED-based lighting unit that includes at least two light sources configured to respectively generate different spectrums of radiation, wherein each different source spectrum may be referred to as a “channel” of the multi-channel lighting unit.

The term “controller” is used herein generally to describe various apparatus relating to the operation of one or more light sources. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

In one network implementation, one or more devices coupled to a network may serve as a controller for one or more other devices coupled to the network (e.g., in a master/slave relationship). In another implementation, a networked environment may include one or more dedicated controllers that are configured to control one or more of the devices coupled to the network. Generally, multiple devices coupled to the network each may have access to data that is present on the communications medium or media; however, a given device may be “addressable” in that it is configured to selectively exchange data with (i.e., receive data from and/or transmit data to) the network, based, for example, on one or more particular identifiers (e.g., “addresses”) assigned to it.

The term “network” as used herein refers to any interconnection of two or more devices (including controllers or processors) that facilitates the transport of information (e.g. for device control, data storage, data exchange, etc.) between any two or more devices and/or among multiple devices coupled to the network. As should be readily appreciated, various implementations of networks suitable for interconnecting multiple devices may include any of a variety of network topologies and employ any of a variety of communication protocols. Additionally, in various networks according to the present disclosure, any one connection between two devices may represent a dedicated connection between the two systems, or alternatively a non-dedicated connection. In addition to carrying information intended for the two devices, such a non-dedicated connection may carry information not necessarily intended for either of the two devices (e.g., an open network connection). Furthermore, it should be readily appreciated that various networks of devices as discussed herein may employ one or more wireless, wire/cable, and/or fiber optic links to facilitate information transport throughout the network.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 illustrates the positioning of the monitoring device between the power supply and the load in accordance with embodiments of the present invention.

FIG. 2 illustrates a monitoring device according to embodiments of the invention.

FIG. 3 illustrates an exploded view of the mechanical assembly of a monitoring device according to embodiments of the invention.

FIG. 4 illustrates a logic diagram relating to the operation of the monitoring device according to embodiments of the invention.

### DETAILED DESCRIPTION

Generally known in the art are power protecting device capable of protecting an electric appliance by cutting the power supply at abnormal conditions like over current, over voltage, under voltage and over power. Such power protecting devices further include a power on delay circuit capable of delaying the power supply to an electric appliance for a predetermined period of time, wherein for example the predetermined time is dependent on the time of power termination. However, after the predetermined period of time, resupply of the power to the load is automatically commenced, which may be detrimental to the load should there be a fault with the power supply or the load, thereby potentially resulting in further damage thereto.

More generally, Applicants have recognized and appreciated that it would be beneficial to provide methods and apparatus that can provide a desired level of monitoring between a power source and a load, while also providing a desired level of protection thereto.

In view of the foregoing, various embodiments and implementations of the present invention are directed to a monitoring device which provides for the monitoring of electrical power flow between a power source and a load, wherein the monitoring device is further configured protect the load. The monitoring device includes a monitoring module configured to monitor one or more aspects of the electrical power flow, for example voltage, current and/or the like. The monitoring module is configured to detect or define a fault condition at least in part when one or more aspects fall outside a predetermined operating range. In addition, the monitoring device further includes a protection module configured to interrupt the electrical power flow upon the identification of a fault condition.

In some embodiments, the monitoring device also includes a reset module, which is configured to re-establish the electrical power flow between the power source and the load following a user-initiated reset action. In some variations of embodiments of the invention, the reset module is further configured to provide a predetermined delay between the user-initiated reset action and re-establishment of electrical power flow.

In addition, and in some embodiments of the invention, the monitoring module includes a fault counter configured to increment a fault count when one or more aspects being monitored fall outside a predetermined operating range. In these embodiments, a fault condition can be determined when the fault count meets or exceeds a predetermined threshold.

In some embodiments of the invention, the monitoring device further includes a diagnostic module which is configured to provide diagnostic information to a user following the determination of a fault condition. This diagnostic information can be based at least in part on the one or more aspects which were being monitored prior to the occurrence of the fault condition.

According to embodiments of the invention, the monitoring device is used to monitor voltage and current delivered from a DC current power supply or LED driver to a load, for example, a light source or LED. The monitoring device is configured to disconnect the load from the power supply if it detects that an error, for example an over current or under/over voltage, or the like, has occurred. Further and in some embodiments of the invention, the monitoring device is configured to indicate the current operating status of the power supply, LED drive and/or load in order to aid in trouble shooting or diagnostics by the user.

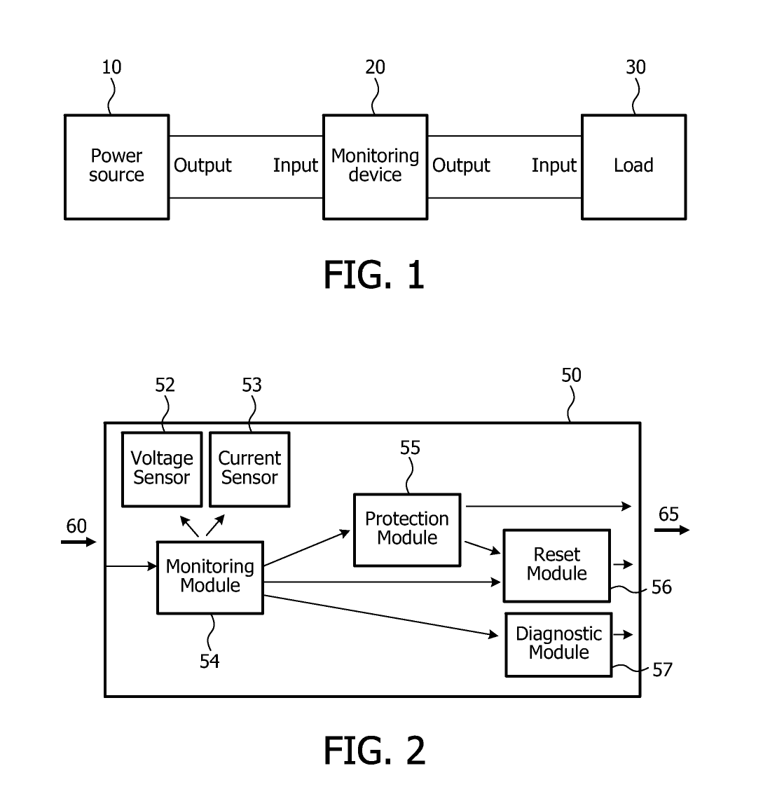

Referring to FIG. 1, in some embodiments of the invention, the monitoring device 20 is configured to be installed in series between a power source 10, for example a power supply, a direct current power supply, a direct current LED driver or the like, and a load 30, for example an electrical appliance, one or more LEDs or the like.

FIG. 2 illustrates a monitoring device 50 in accordance with embodiments of the invention wherein the monitoring device 50 receives a signal 60 from the power source, and provides a signal 65 to the load. The monitoring device 50 receives electrical power flow from the power source, wherein the monitoring module 54 is configured to periodically measure one or more aspects of the electrical power flow, for example one or more of the input voltage from the direct current power supply or LED driver, the current supplied to the load and/or the like. For example, a voltage sensor 52 can be used to measure the input voltage and a current sensor 53 can be used to measure the direct current. In some embodiments, the monitoring module 54 can be configured to compare one or more of the monitored aspects with one or more predetermined thresholds, for example, an averaged voltage measurement, averaged current measurement, or other predetermined threshold which can define normal or predetermined operational parameters of the power source and/or load. In embodiments, should one or both of the measured aspects fall outside the predetermined thresholds, the monitoring module 54 can provide the protection module 55 with a signal to disconnect the load from the power source. In some embodiments of the invention a diagnostic module 57 is provided with a signal such that the diagnostic module can determine and or display an appropriate error code to help the user troubleshoot the problem. The reset module 56 is configured to re-establish electrical power flow following a reset action, for example a user activated reset action.

It will be readily understood by worker skilled in the art, that while the monitoring module, protection module, reset module and the diagnostic module are illustrated as separate modules, two or more of these modules can be integrated together as a single module while providing the desired functionality of the multiple modules integrated therein. Furthermore, a module can be realized in a plurality of manners, for example in hardware, software, firmware or combinations thereof, wherein depending on the configuration of module, required components required may be determined, for example controllers, microprocessors and/or the like.

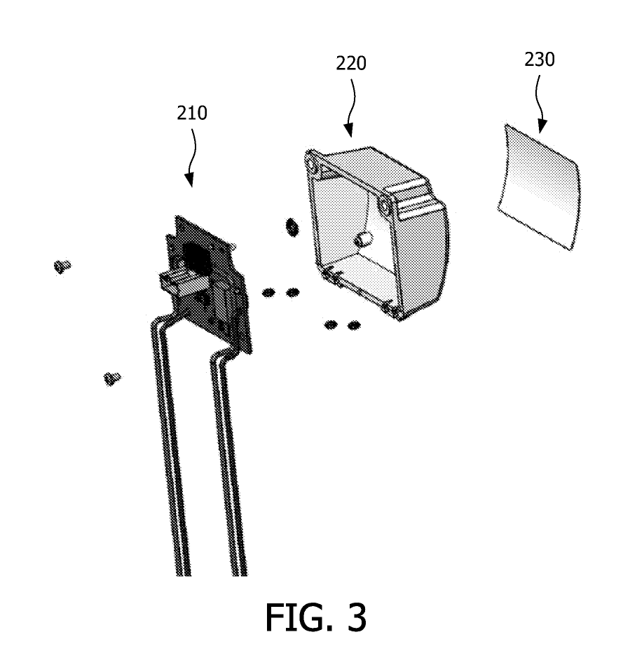

FIG. 3 illustrates an exploded view of a monitoring device according to one embodiment of the invention, wherein the monitoring device includes a circuit board component 210, which is concealed and protected by an enclosure 220 having an optical element 230 associated therewith for viewing of a display device associated with the monitoring device.

### Monitoring Module

The monitoring module is configured to monitor one or more aspects of the electrical power flow between the power source and the load. For example, the monitoring module can monitor electrical power flow parameters including one or more of voltage, current, power, or the like. The monitoring module is configured to determine a fault condition at least in part through the comparison of one or more of the measured aspects with a predetermined operating range thereof. Upon the detection of a fault condition, the monitoring module provides one or more signals to the protection module for interruption of the electrical power flow between the power source and the load.

In some embodiments of the invention, upon detection of a fault condition, the monitoring module provides one or more signals to a diagnostic module, which can generate diagnostic information based at least in part on the one or more aspects of the electrical power flow between the power source and the load.

In some embodiments of the invention, the monitoring module includes one or more current sensors configured to monitor the current of the electrical power flow. For example, the one or more current sensors can be configured to measure the instantaneous forward current supplied by the power source to the load. As the current that is being supplied to the load is being measured, this provides a means for comparing this measured current with a defined limit, which may be defined based on the characteristics of the load, for example. The current sensor can be a fixed resistor, a variable resistor, an inductor, a Hall effect current sensor, or other element which has a known voltage-current relationship and can provide a measurement of the current flowing from the electrical power source to the load, which in some instances can be based on a measured voltage signal.

In some embodiments of the invention, the monitoring module includes one or more voltage sensors that are positioned between the power source and the load and configured to measure the instantaneous forward voltage to the load. As the voltage that is being supplied to the load is being measured, this provides a means for comparing this measured voltage with a defined limit, which may be defined based on the characteristics of the load, for example.

In some embodiments, the monitoring module is configured to periodically measure one or more aspects of the electrical power flow, for example one or more of the input voltage from the direct current power supply or LED driver, the current supplied to the load and/or the like. In some embodiments, the monitoring module is configured to continuously measure one or more aspects of the electrical power flow.

In some embodiments, the monitoring module is configured to average one more of these monitored aspects, and compare this average with one or more predetermined thresholds, for example, an averaged voltage measurement or averaged current measurement can be compared with a related predetermined threshold, wherein a predetermined threshold can define normal operation of the power source and/or load. In some embodiments, if one or more of the measured values fall outside the limits a fault condition is determined.

If one or more of the measured values fall outside the limits an error accumulator will be incremented and when the error accumulator reaches or exceeds a predetermined value, the monitoring module determines a fault condition. The use of an error accumulator may provide a means for avoiding unnecessary fault conditions under operating conditions should one or more of the monitored aspects be outside of the predetermined range due to for example, inaccuracy of one or more of the sensors or other reason as would be readily understood by a worker skilled in the art.

In some embodiments of the invention, the difference between the monitored aspect of the electrical power flow and the predetermined limit thereof, may be used as an indicator of a fault condition. For example, exceeding a predetermined limit by a small amount may not have the same effect on the load or power source as when the difference is large. As such a large difference may result in an immediate fault condition, and multiple small differences may have to occur for a fault condition to be determined. As would be readily understood, the terms small and large can be determined relative to the aspect being monitored, the power source, the load, and the ability thereof to mitigate large and/or small differences between measured operating aspects and normal operating levels of the same aspects.

Upon determination of a fault condition, the protection module is configured to interrupt the electrical power flow between the power source and the load.

The monitoring module may further include a daytime detection module, which is configured to determine if it is daytime or night time. For example, should the daytime detection module determine that it is daytime, this module can be configured to disconnect the power source from the load, thereby conserving power during there periods of sufficient ambient light. In some embodiments, the daylight detection module comprises one or more optical sensors configured to detect ambient light. The daylight module is configured to determine if it is daylight based on a comparison of the detected ambient light with a predetermined threshold which defines daylight conditions.

### Diagnostic Module

In various embodiments of the invention, the monitoring device includes a diagnostic module which is configured to provide diagnostic information which is based at least in part on the one or more aspects of the electrical power flow being monitored. For example, the diagnostic module can provide diagnostic information based on the one or more aspects as they were prior to the determination of a fault condition.

In some embodiments of the invention, an information presentation device is operatively coupled to the diagnostic module and is configured to provide one or more visual and/or audible indications to a user, thereby providing the user with diagnostic information which is represented by the one or more indications. For example, the information presentation device can be an alpha-numeric display, a graphical display, a speaker system or other audible or visual system, or combinations thereof.

In embodiments of the invention, the diagnostic module includes a display device which enables the presentation of information to a user, which may be used for trouble shooting, should a fault condition have been determined, and/or for indicating that the electrical power flow between the power source and the load is within predetermined operating parameters, as based at least in part on the one or more aspects that are being monitored.

In some embodiments, while in a diagnostic mode, the diagnostic module will display an appropriate error code or other diagnostic information to help the user troubleshoot the problem which may have resulted in the fault condition being determined. In some embodiments, different error codes are defined and indicative of a combination of the one or more aspects of the electrical power flow being monitored. For example, in some embodiments an error code is indicative of the voltage and/or current limit violations which occurred and resulted in the fault condition.

In some embodiments, upon determination of a fault condition, the monitoring device can latch into a diagnostic mode until the electrical power flow is re-established, for example, by resetting of the power source. For example, latching in a protected or diagnostic mode after a fault condition has been detected, rather than continuous re-application of power to the load, may prevent severe damage to the load.

### Reset Module

The reset module is configured to re-establish the electrical power flow after the protection module has interrupted the electrical power flow due to the determination of a fault condition. In some embodiments of the invention, the reset module is configured to be responsive to a user-initiated reset action.

In some embodiments of the invention, the reset module is configured for a delayed re-establishment of electrical power flow following a reset action. In this manner, start-up stress on the load and/or power source, due to re-establishment of electrical power flow may be reduced.

The delay is generally defined as a fixed or a variable period of time from the initial reset action. In some embodiments, the delay can be determined as being dependent on the diagnostic information reflective of the determined fault condition.

In many embodiments, the reset module is configured to gradually increase the electrical power flow, until it reaches a desired level, thereby enabling the reduction of stress on the power supply and/or load which may occur during sudden re-establishment of electrical power flow.

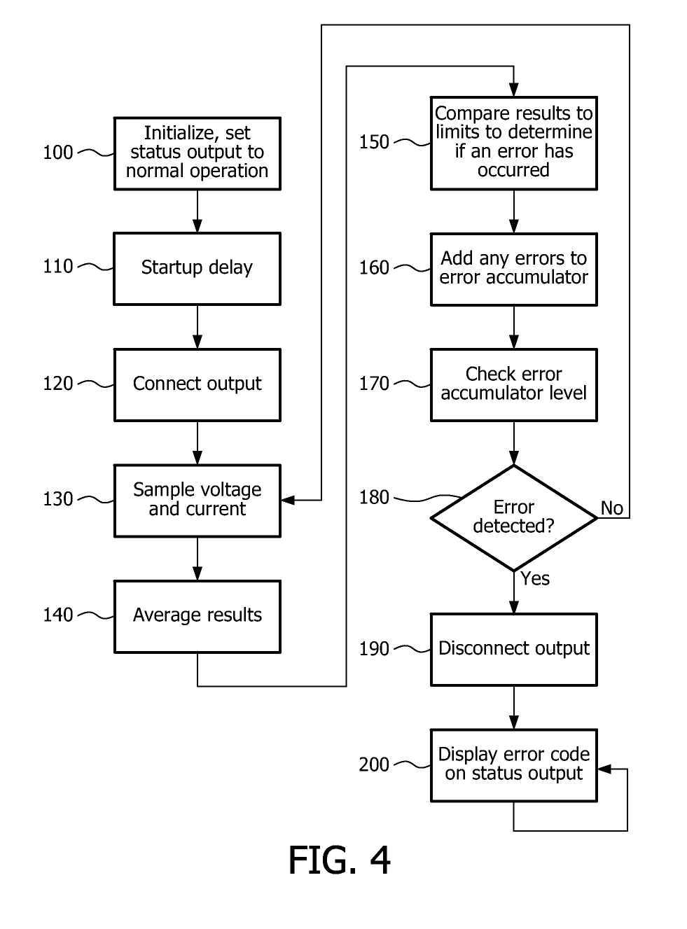

FIG. 4 illustrates a logic flow diagram of a method of operation of a monitoring device in accordance with embodiments of the invention. The monitoring device is initialized and the status is set to normal operation 100. There is a subsequent delay of a predetermined period of time 110 following which the electrical power flow is established 120 between the power source and the load. The monitoring device samples the voltage and the current 130 of the electrical power flow one or more times and subsequently averages these results 140. These averaged results for voltage and current are subsequently compared with predetermined operation limits associated therewith 150. Should the averaged results, for example meet or exceed the predetermined limits associated therewith, an error is determined 150, at which point this error is added to those previously occurred, if any, in the error accumulator 160. The monitoring device subsequently examines the error accumulator 170, and should the error accumulator exceed or equal a predetermined value 180 a fault condition is determined. Upon determination of a fault condition, the monitoring device interrupts or disconnects the electrical power flow between the power supply and the load 190 and the monitoring module further displays an error code indicative of the fault condition 200, which may assist a user with troubleshooting the problem. Upon resetting of the power source, load and/or monitoring device, the sequence of events commences at initialization 100. However, as illustrated in FIG. 4, should the monitoring device determine that a fault condition has not occurred 180, the monitoring device will return to sampling the voltage and current 130, and continue with the subsequent steps as defined above.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

What is claimed is:

1. A device for monitoring an electrical power flow between a power source and a load, and for protecting the load, the device comprising:
a) a monitoring module configured to monitor one or more aspects of the electrical power flow, the monitoring module configured to detect a fault condition when one or more aspects fall outside a predetermined operating range; and
b) a protection module configured to interrupt the electrical power flow upon detection of the fault condition.

2. The device according to claim 1, further comprising a reset module configured to re-establish the electrical power flow following a user-initiated reset action, the reset module further configured to provide a predetermined delay between the user-initiated reset action and re-establishing the electrical power flow.

3. The device according to claim 1, wherein the monitoring module further comprises a fault counter configured to increment a fault count when the one or more aspects fall outside a predetermined operating range, wherein the fault condition is determined when said fault count exceeds or equals a predetermined threshold.

4. The device according to claim 3, further comprising a reset module configured to re-establish the electrical power flow following a reset action.

5. The device according to claim 4, wherein the reset module is configured to re-establish the electrical power flow after a predetermined period of time following the reset action.

6. The device according to claim 1, further comprising a diagnostic module configured to provide diagnostic information to a user following detection of the fault condition, said diagnostic information based at least on the one or more aspects monitored prior to the fault condition.

7. The device according to claim 1, wherein the monitoring module is configured to sample current and/or voltage of the electrical power flow.

8. The device according to claim 1, wherein the monitoring module is configured to determine an average value for each of the one or more aspects being monitored.

9. The device according to claim 2, wherein the reset module is configured to re-establish electrical power flow by increasing the electrical power flow in a linear or step wise manner.

10. The device according to claim 6, wherein the diagnostic module is configured to provide a user with an error code indicative of the fault condition.

11. A method for monitoring and controlling electrical power flow from a power source to a load, the method comprising the steps of:
a) sampling one or more aspects of the electrical power flow;
b) comparing the one or more aspects with a predetermined operating range associated therewith;
c) determining a fault condition at least in part when the one or more aspects are outside of the predetermined operating range; and
d) interrupting the electrical power flow upon determination of a fault condition.

12. The method according to claim 11, further comprising the step of re-establishing the electrical power flow following a user-initiated reset action.

13. The method according to claim 12, wherein the step of re-establishing electrical power flow commences after a predetermined delay after the user-initiated reset action.

14. The method according to claim 11, wherein after comparing the one or more aspects, and when the one or more aspects are outside of the predetermined operating range, adding a fault to a fault count of a fault count accumulator.

15. The method according to claim 14, wherein determining a fault condition includes comparing the fault count with a predetermined number, wherein a fault condition is defined by the fault count meeting or exceeding the predetermined number.

16. The method according to claim 14, further comprising the step of generating diagnostic information indicative of the fault condition.
